(19) United States
(12) Patent Application Publication
(10) Pub. No.: US 2007/0140684 A1
(43) Pub. Date: Jun. 21, 2007

(54) Case for digital camera

(76) Inventor: Chun Chee Tsang, Kwai Fong (HK)

Correspondence Address: BOHAN, MATHERS & ASSOCIATES, LLC, PO BOX 17707, PORTLAND, ME, 04112-8707, US

(21) Appl. No.: 11/304,178

(22) Filed: Dec. 15, 2005

(51) Int. Cl. G03B 17/00

(52) U.S. Cl. 396/419

(57) ABSTRACT

A protective case for a digital camera. The case has a retainer for holding the camera and a protective sleeve that slips over the retainer and camera, thereby forming a complete enclosure for the camera. The sleeve is pivotably attached to the retainer and, due to an extendable hinge means, is able to pivot 270 degrees about a pivot point on the retainer. By doing so, a surface of the sleeve is brought directly beneath the base of the retainer in a manner that provides support for the retainer. A leg means is also incorporated into the sleeve. This leg may be pulled away from the sleeve. The sleeve and leg together, when resting on a flat surface, provide a support for the retainer and the camera.

### BACKGROUND INFORMATION

1. Field of the Invention

The invention relates to the field of cases cases for handheld devices. More particularly, the invention relates to a protective case for a digital camera.

2. Description of the Prior Art

Digital cameras are widely used today. As with all electronic devices, cameras are delicate. For this reason, care must be taken in their storage and handling and most users carry their camera in a protective camera case. Typically, the protective case is constructed of a sturdy, rigid material that securely holds the camera and protects it from damage. Ideally, the case allows easy access to the camera that makes it readily available for immediate use. Often, in order to use the camera, a protective cover of the camera case must be separated and removed from the case. In some cases, even the camera must be removed from the case. It is a disadvantage to not be able to use the camera while it is in the case and it is a further disadvantage that the user must keep track of the whereabouts of the case, or at least the case cover.

Users often have difficulty holding a camera steady enough to capture a clear image and it is often advantageous to use a sturdy, stand-alone platform to support the camera. A camera tripod is typically used for such a purpose. If such a stand is desired, then the user must provide, carry, assemble, and keep track of the tripod, a separate device that is often quite large and bulky.

Data for digital photographs may be conveniently stored on a digital storage device, also called a picture card. The advantages of the picture card are that it is readily interchangeable with other picture cards, and easily inserted into or removed from the camera. Users often carry spare picture cards so as to have the extra storage available. As with all electronic storage media, care must be taken in storing and handling such cards. The conventional picture card is small and flat, and easily transportable. It is also easily misplaced or damaged. Protective cases for digital storage devices, including picture cards, are known, but, being separate from the camera case, the user may have to search around to locate the case. This is a disadvantage when the user is in the middle of taking photographs and would like to exchange the storage device quickly.

What is needed, therefore, is a protective case for a camera that allows the camera to be used while in the case. What is further needed is such a case in which the lid remains attached to the protective case and does not encumber use of the camera. What is yet further needed is such a case that facilitates a steady hold on the camera and that may also serve as a stand-alone support for the camera. What is still yet further needed is such a case that provides a means for handily storing digital storage devices used by the camera.

### BRIEF SUMMARY OF THE INVENTION

The above-cited needs are satisfied by a digital camera case that securely holds and protects a digital camera. The digital camera case according to the invention comprises a retainer, a protective sleeve, a hinge means for pivotably connecting the protective sleeve to the retainer, and an optional support leg or strut. The protective sleeve pivots away from the retainer, exposing the front face of the camera, as well as the viewfinder and the control panel on the rear face of the camera. The sleeve is able to rotate through a 270-degree arc, bringing the sleeve down below the retainer in a manner that allows the base of the retainer to be supported on the sleeve. In this orientation, the protective sleeve may serve as a handle for the user to grasp, or may serve as a stand-alone support stand for the retainer and camera. The optional strut or support leg is incorporated into the sleeve and may be pulled out as needed to provide additional support.

The retainer has an open front face, providing an unimpeded field of view for the camera lens. Apertures are provided on a rear face of the retainer, providing access to the LCD viewfinder and the control panel or buttons on the rear face of the digital camera. The apertures may be fitted with easily removable plugs, for added protection of the camera when it is not in use. For example, a clear plastic plug may be used to protect the LCD viewfinder.

In the closed or 0-degree rotation position, the protective sleeve covers the retainer and, together with the retainer, provides a secure, completely closed protective case for the camera. The hinge means for pivotably connecting the protective sleeve with the retainer is extendable relative to the body of the retainer, thus allowing the protective sleeve to pivot through an arc of 270 degrees. In the fully open or 270-degree position, the protective sleeve is directly beneath the base of the retainer and the retainer rests securely and squarely on top of the protective sleeve. The protective sleeve, in this orientation, may serve as a handle that provides a comfortable and secure means for the user to hold the camera.

The protective sleeve of the digital camera case may also serve as a stand-alone support stand, either with or without the optional leg. The support leg is pivotably attached to the protective sleeve. When not in use, the leg lies flat in a channel provided therefore in a surface of the sleeve. When needed to provide additional support to the sleeve that is now serving as a stand-alone support stand, the leg is pivoted away from the body of the sleeve. The leg now, together with the sleeve, forms a triangular support stand, similar in function to that of the well-known tripod. If the sleeve, in this 270-degree orientation, is placed upon a flat surface, it and the leg provide a support stand that holds the retainer with digital camera in a steady position. A strap loop is attached to the foot end of the leg and may be used to attach a strap or cord to the digital camera case.

A storage means for storing a digital storage device may also be incorporated into the case as an optional feature. Such a digital storage device includes conventional digital media or picture cards. The storage means is formed by a recess and a frame in a side wall of the protective sleeve. The recess extends outward from an inner face of the side wall and the frame is mounted over the recess on the inner face. The frame is open at one edge, allowing the picture cards to be slidably inserted into or removed from the storage area. Depending on the type and size of the storage device, the frame may be subdivided into compartments to accommodate several storage devices. The frame and the recess may be adapted to store any size, shape, and number of digital storage devices known to the art.

The digital camera case according to the invention is preferably constructed of a rigid material, such as metal, plastic, or other form rigid material that provides the necessary rigidity and strength to protect the camera stored within the case. The inside of the digital camera case may be lined with a material that supports, holds in place the device being held by the case, and/or provides some shock absorption.

### BRIEF DESCRIPTION OF THE DRAWINGS

The present invention is described with reference to the accompanying drawings. In the drawings, like reference numbers indicate identical or functionally similar elements.

FIG. 1 is an illustration of the digital camera case according to the invention, showing the retainer, the protective sleeve, the extendable hinge means, and the support leg, whereby the protective sleeve and leg are serving as a stand-alone support.

FIG. 2 is a perspective view of the front of the closed digital camera case.

FIG. 3 is a perspective view of the rear of the closed digital camera case.

FIG. 4 is a top planar view of the retainer, showing the slide channel and the open front face.

FIG. 5A illustrates the hinge means, with the hinge slide retracted into the retainer.

FIG. 5B illustrates the hinge means, with the hinge slide in a fully extended position.

FIG. 6A is a partial elevational view of the digital camera case, with the protective sleeve rotated 180 degrees from the closed position.

FIG. 6B is a partial elevational view of the digital camera case with the protective sleeve rotated 180 degrees from the close position and with the hinge means extended.

FIG. 7A is a top plane view of the digital camera case of FIG. 2.

FIG. 7B is an elevational view of the leg rotated slightly away from the upper sleeve face.

FIG. 8 is a perspective view of the sleeve, showing the open side and channel for the leg.

FIG. 8A is a elevational view of the inner face of the rear sleeve wall of the protective sleeve, showing the storage means for storing storage devices.

FIG. 8B is a top plane partial view of the rear sleeve wall, showing the storage means with insert slot for storing storage devices.

FIG. 9 is a perspective view of the leg pivot means.

FIG. 10 illustrates the sleeve serving as a handle for the human hand to grasp.

FIG. 11 shows the removable plug for the aperture for the LCD viewfinder.

### DETAILED DESCRIPTION OF THE INVENTION

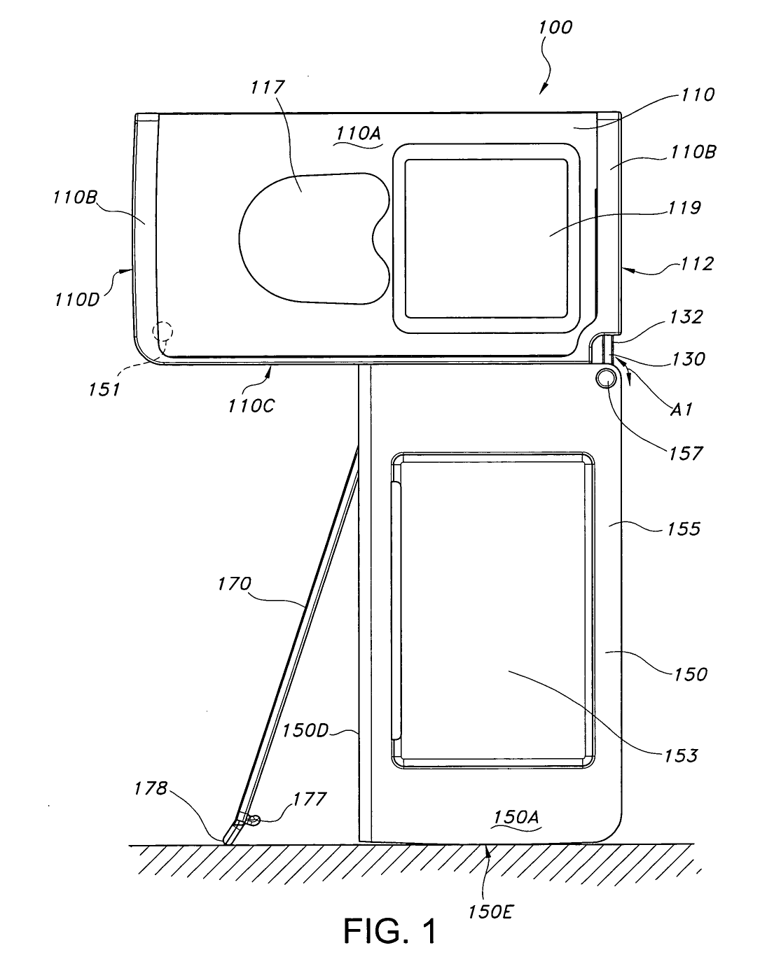

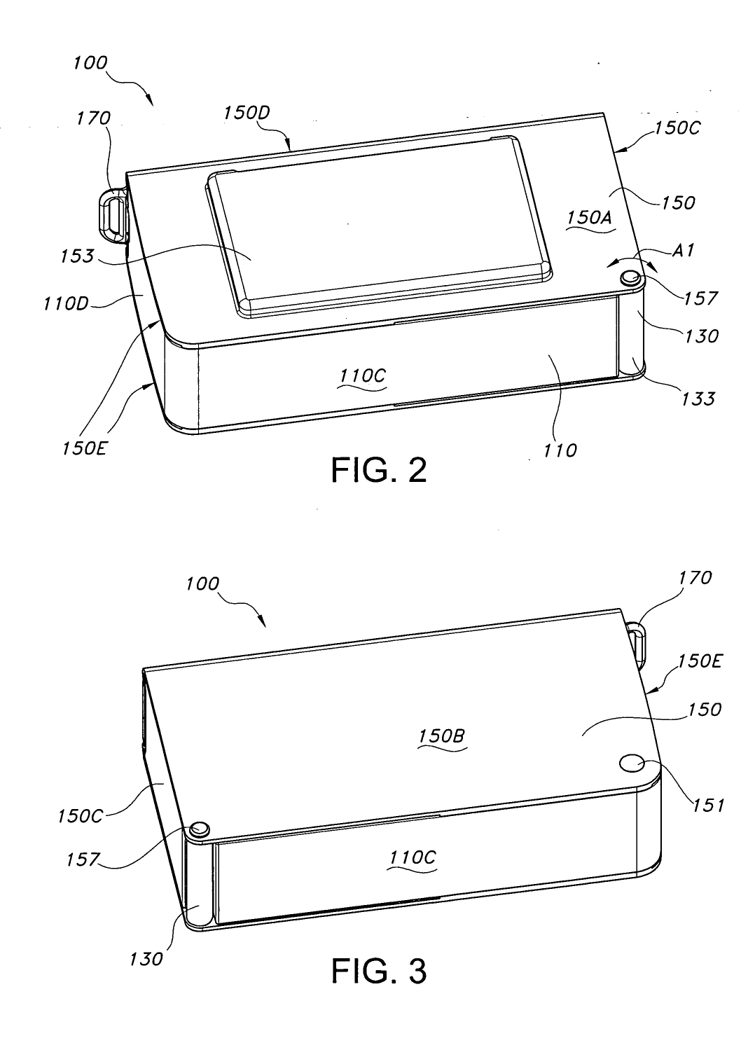

FIGS. 1-3 illustrate a digital camera case 100 according to the invention that is a protective case for a digital camera. FIG. 1 illustrates a key feature of the invention: the ability of the protective sleeve 150 to support the retainer and thereby to serve as a stand-alone support or as a handle. FIGS. 2 and 3 show perspective views of the front and rear faces of the closed digital camera case 100, respectively. The digital camera case 100 comprises a retainer 110, a protective sleeve 150, an extendable hinge means 130, and a leg means 170. The retainer 110 and the protective sleeve 150 are pivotably connected to one another via the hinge means 130. In the closed position, also referred to as a “0-degree” position, the protective sleeve 150 covers the retainer 110 and the camera is completely enclosed within the digital camera case 100, as shown in FIGS. 2 and 3. The protective sleeve 150 has a front sleeve wall 150A, a rear sleeve wall 150B, a closed sleeve side 150C, an upper sleeve face 150D, and an open sleeve side 150E. Closure means 151 are provided on the digital camera case 100 to releasably secure the sleeve 150 over the retainer 110. In the embodiment shown, the closure means 151 comprise a conventional closure, such as a mating button and recess configuration with an interference fit that serves to hold the protective sleeve 150 over the retainer 110, until intentionally released. It should be understood that any suitable closure means 151 may be used, such as snap pawls, snap buttons, latches, straps, etc.

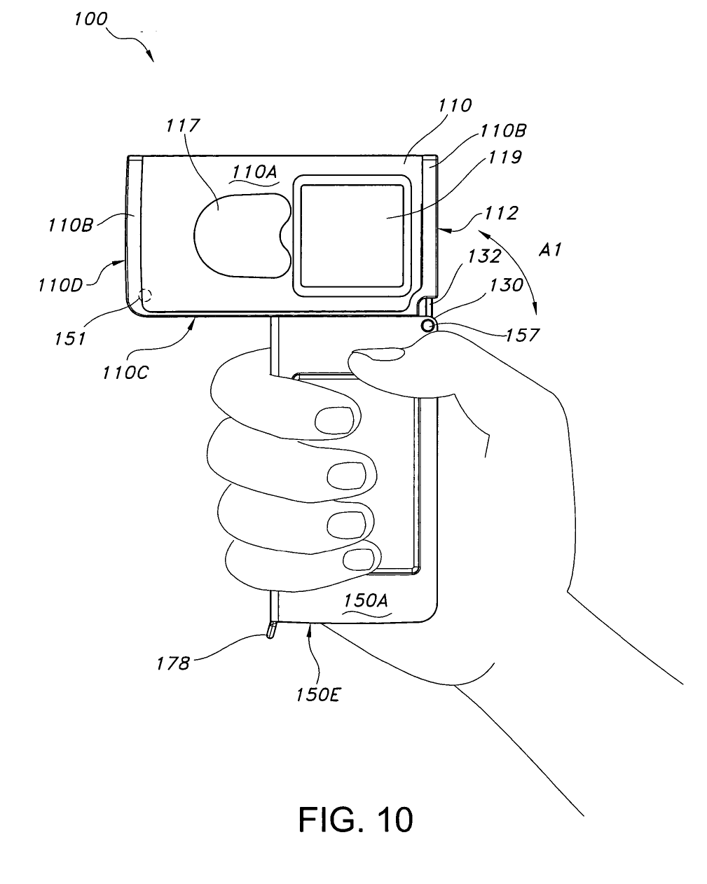

FIG. 10 is an illustration of the digital camera case 100, in the orientation shown in FIG. 1, with the leg means 170 folded up against the protective sleeve 150. The protective sleeve 150 serves as a handle and, as shown, may be grasped by a hand.

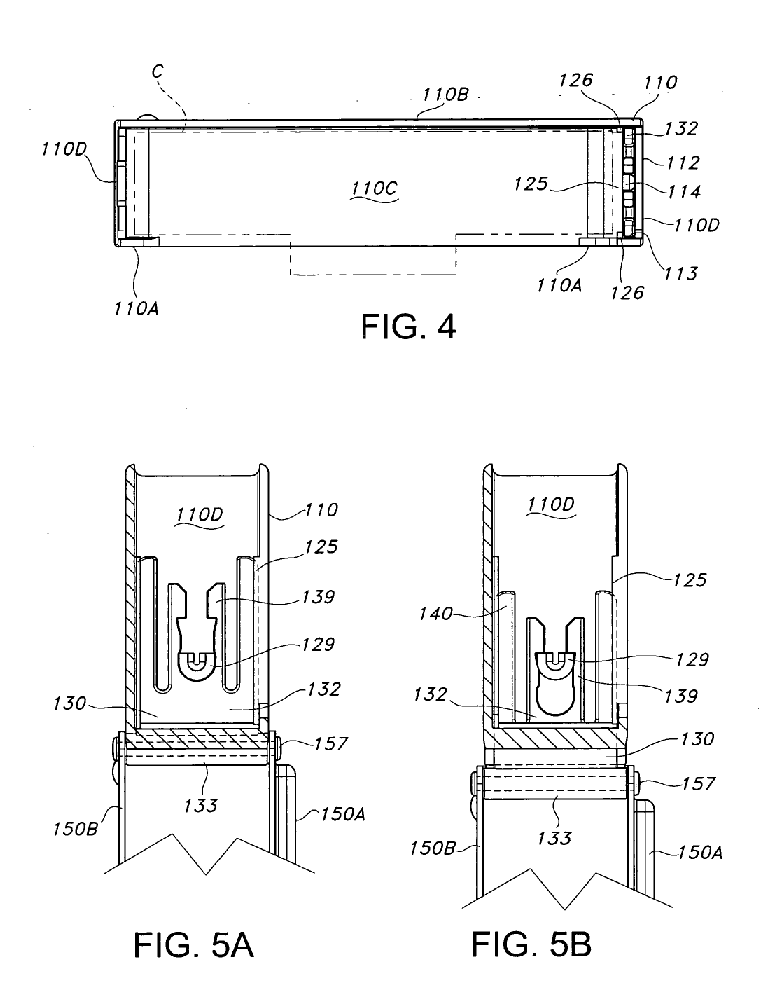

FIG. 4, along with FIG. 1, illustrates the open contour of the retainer 110. A camera C is drawn in with dashed lines for illustration purposes. The retainer 110 has a rear retainer face 110B, a front retainer face 110A, two retainer sidewalls 110D, and a retainer base 110C. The rear retainer face 110B faces the user when the camera C is being used in a conventional manner. A control panel aperture 117 and an LCD viewfinder aperture 119 are provided in the rear retainer face 110B, to enable operation of the camera C while it is in the retainer 110. The front retainer face 110A is an open face, with edges that are wide enough to hold the camera C within the retainer, yet narrow enough to provide an unimpeded field of view for the camera lens. The camera C is inserted from above into the retainer 110. Two channel guides 126 form a slide channel 125 in one of the side walls 110D.

FIGS. 5A and 5B are cross-sectional views of the sidewall 110D, showing the extendable hinge means 130 assembled in the sidewall 110D. These figures illustrate that the extendable hinge means 130 is extendable relative to the body of the retainer 110. The hinge means 130 includes a hinge slide 132 captured in the slide channel 125 and a hinge pin 157 in a lower end 133 of the hinge slide 132. FIG. 5A shows the hinge slide 132 in its retracted position within the slide channel 125, with just the lower end 133 extending beyond the side wall 110D. The slide channel 125 is open at the bottom, allowing the body of the hinge slide 132 to move slidingly through the opening. The lower end 133 of the hinge slide 132 is dimensioned such that it cannot move into the slide channel 125. A slide stop 129 is provided in the slide channel 125. Stop guides 139 on the hinge slide 132 limit the travel of the slide 132 against the slide stop 129. FIG. 5B shows the same hinge slide 132 in its fully extended position, with the lower end 133 of the hinge slide 132 moved downward out of the slide channel 125.

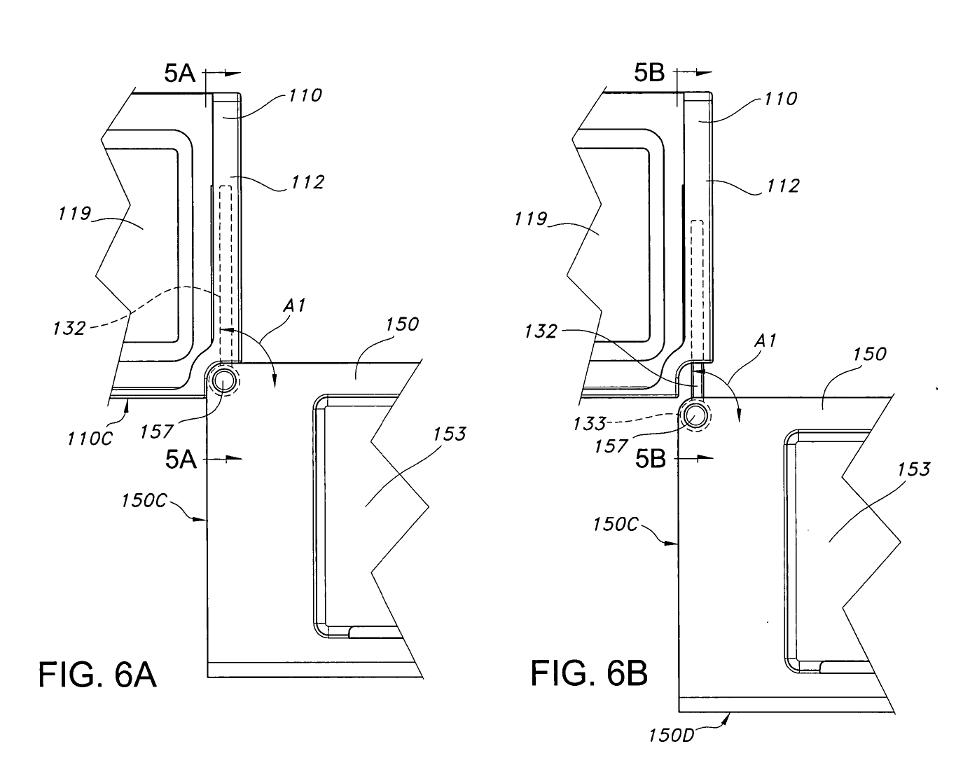

FIGS. 6A and 6B are partial plane views of the digital camera case 100, showing the fully retracted and fully extended positions of the hinge slide 132, respectively. Rotational arrow A1 illustrates the rotation of the protective sleeve 150 about the hinge pin 157. When the protective sleeve 150 is in the 0-degree or closed position, shown in FIGS. 2 and 3, the lower end 133 of the hinge slide 132 is flush with the outer contour of the retainer 110. When the protective sleeve 150 is rotated 180 degrees from the 0-degree position, the retainer base 110C and the upper sleeve face 150D are aligned along a parallel plane. When the hinge slide 132 pulled to its fully extended position, the protective sleeve 150 is rotatable 270 degrees from the 0-degree position and the upper sleeve face 150D is now beneath the retainer base 110C and in an orientation to support the retainer 110, as shown in FIG. 1. In other embodiments, the lower end 133 of the hinge slide 132 containing the hinge pin 157 protrudes fixedly below the retainer base 110C, so as to enable the protective sleeve 150 to swing about the retainer 110 without having the hinge means having to be extendable. A leg means 170 is shown in FIG. 1, which may be used optionally to provide additional support to the protective sleeve 150, when the sleeve is used as a stand-alone support.

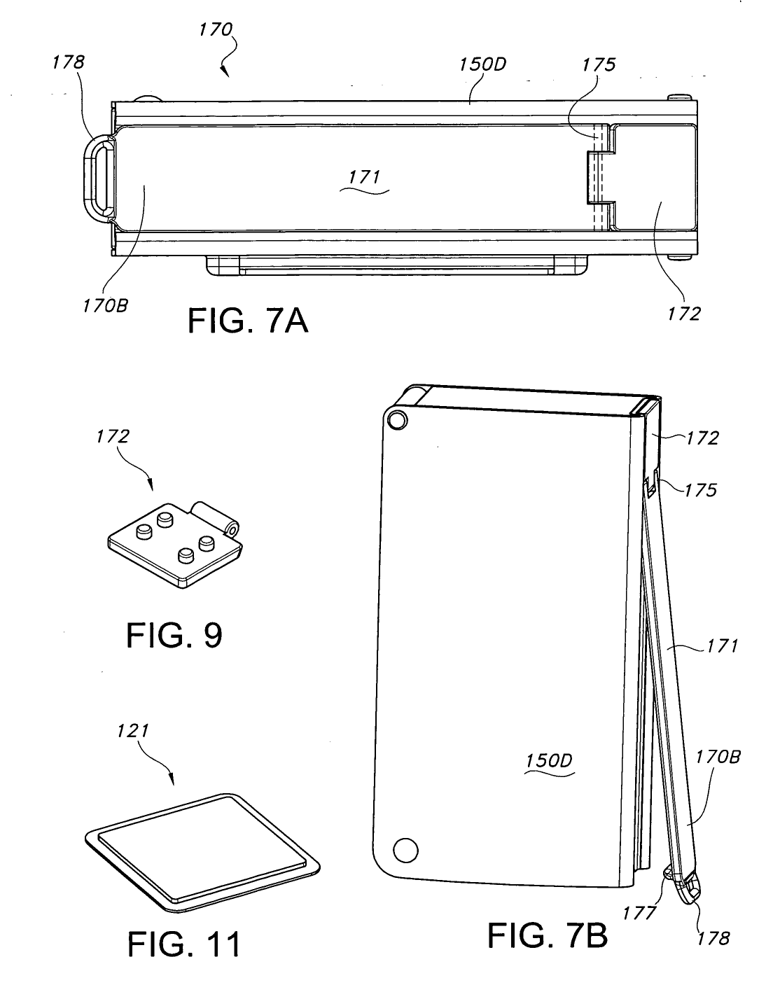

FIGS. 7A and 7B illustrate the leg means 170 that is provided in the upper sleeve face 150D of the protective sleeve 150. In the embodiment shown, the leg means 170 includes a leg pivot means 172 that is incorporated into the upper sleeve face 150D, a pivot pin 175, and a strut or leg 171 that is coupled to the pivot pin 175. As shown in FIG. 1, the leg 171, when rotated out away from the body of the protective sleeve 150, provides a triangular support leg for reliably supporting the retainer 110 on the protective sleeve 150. A strap loop 178 is provided at a lower end 170B of the leg 171. The user may attach a strap or cord to the strap loop 178, that may be used to carry the digital camera case 100. A leg latching means 177 is also provided, for securing the leg 171 against the upper sleeve face 150D of the protective sleeve 150 when the leg means 170 is not needed. In the embodiment shown, the leg latching means 177 is a pawl that catches on a lower edge of the upper sleeve face 150D of the sleeve 150. FIG. 7C shows an embodiment of the leg pivot means 172.

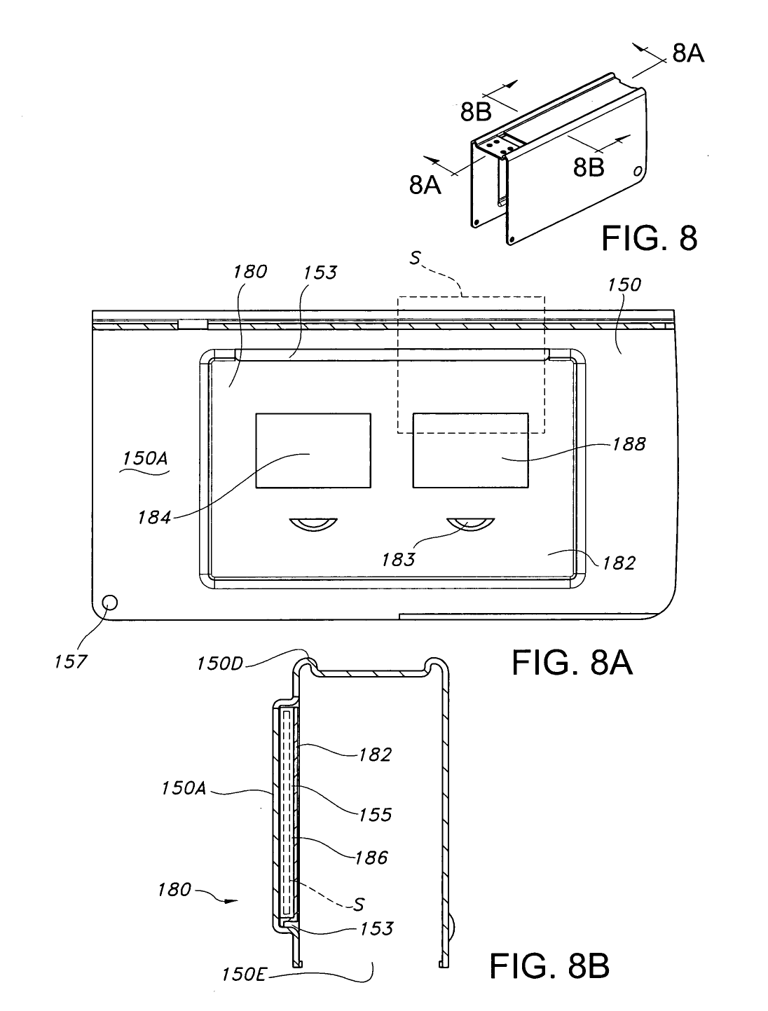

FIG. 8 is a perspective view of the sleeve 150, showing the open side and providing orientation for FIGS. 8A and 8B, that are plane views illustrating a storage means 180 for storing one or more storage devices S (shown in dashed lines). The storage means is a card retainer formed by a frame 182 that is fitted over a recess 153 that is formed in the inner face of the front sleeve wall 150A. The recess 153 and the frame 182 form an insert slot 155, via which the storage device S is inserted into or removed from the storage means 180. The storage means 180 provides a protective enclosure for storing spare storage devices S. Ideally, the frame 182 lies within the frame recess 153, which is of sufficient depth so that the body of the frame 182 is flush with the inside surface of the protective sleeve 150 and does not protrude into the inner space formed by the walls of the protective sleeve 150. The frame 182 may be constructed to have multiple compartments 188 so as to accommodate multiple storage devices S. In the embodiment shown, and for illustration purposes only, the storage means 180 has two compartments 188, separated by a divider 186, to store two storage devices S. Although the slot 155 is open on the outside of the sleeve 150A, the storage devices S are accessible only when the digital camera case 100 is open, that is, with the protective sleeve 150 rotated away from the body of the retainer 110. The storage devices S simply slide into the storage means 180 via the slot 155, but fit snugly enough within the storage means 180 that force must be exerted on them to move them out of the storage means. A finger recess 183 provided on the inner face of the front sleeve wall 150A is provided for this purpose and allows the user to easily remove the storage device S from the storage means 180. For convenience, a label aperture 184 is provided in the frame 182, to enable the user to read the label on the storage device S. The frame 182 is fixedly attached in the recess 153. In the embodiment shown, adhesive is used to secure the frame 182 to the protective sleeve 150, although any suitable means may be used, such as a snap fit in which the frame 182 snaps into the rear sleeve wall 150B or an arrangement in which the frame 182 slides into grooves provided in the sleeve wall, etc. The storage means 180 shown in FIGS. 8A and 8B is adapted to receive and hold XD picture cards, although it should be understood that the storage means 180 may be adapted to any store any size and shape digital storage devices known to the art.

FIG. 11 is a perspective view of a removable plug 121 that may be provided to protect the LCD viewfinder on the digital camera C, when it is not in use. In the embodiment shown, the plug 121 is constructed so as to snap into the LCD aperture 119. Ideally, the removable plug 121 is transparent so that it is not necessary to remove it in order to view images in the LCD viewfinder.

The size and shape of the digital camera case 100 is ideally constructed to closely correspond to the size and shape of a particular digital camera C. For illustration purposes, the particular embodiment of the digital camera case 100 shown herein is a case for a Canon Powershot SD20 camera. The number, size, shape and position of apertures and plugs in the retainer 110 are similarly dependent upon the locations of the operational components of the specific digital camera intended to be stored within the case. The preferred embodiment of the invention is for a handheld digital camera. The scope of the invention includes a case for handheld devices.

The digital camera case 100 is preferably constructed of a rigid material, such as metal, plastic, or other form rigid material that provides the necessary rigidity and strength to protect the camera stored within the case. The inside of the digital camera case 100 may be lined with a material that supports and holds in place the device being held by the case and/or provides some shock absorption. In the preferred embodiment, the protective sleeve 150 is made of aluminum or magnesium and the retainer made of plastic. The removable plug 121 is preferably constructed of a clear plastic.

The embodiments of the invention mentioned herein are merely illustrative of the present invention. It should be understood that a person skilled in the art may contemplate many variations in construction of the present invention in view of the following claims without straying from the intended scope and field of the invention herein disclosed.

What is claimed is:

1: A case for a handheld device, said case comprising:
a protective sleeve having a closed sleeve side;
a retainer having a retainer base; and
a hinge means;
wherein said protective sleeve is pivotably attached to a pivot point on said hinge means to said retainer, so as to pivot about said closed sleeve side 270 degrees such that said closed sleeve side serves as a support surface for said retainer base.

2: The case of claim 1, wherein said hinge means is an extendable hinge means for lowering said pivot point away from said retainer.

3: The case of claim 2, wherein said retainer has a side wall with an open end and a slide channel, and wherein said extendable hinge means includes a hinge slide with a hinge and hinge pin provided at a lower end of said hinge slide, and wherein said hinge slide is slidingly captured in said slide channel such through said open end such that a distance of said hinge pin to said retainer base is adjustable.

4: The case of claim 3, wherein said hinge slide has stop guides and wherein said slide channel has a slide stop such that said stop guides and said slide stop limit travel of said hinge slide within said slide channel.

5: The case of claim 1, wherein said protective sleeve has an open sleeve side and where said protective sleeve is rotatable 270 degrees about said pivot point, so that said open sleeve side provides a free-standing support means for supporting said protective sleeve and said retainer on a surface.

6: The case of claim 5, wherein said protective sleeve has an upper sleeve face and wherein a leg pivot means is pivotably attached to said upper sleeve face so as to pivot away from said upper sleeve face and provide a support leg for supporting said retainer on a surface.

7: The case of claim 1, wherein said retainer further includes a rear retainer face, a front retainer face, and two retainer sidewalls therebetween, wherein said front retainer face is an open face provided with retaining means to hold a camera, and wherein said camera is insertable into said retainer from above and operable while held within said retainer.

8: The case of claim 1, wherein said camera has a control panel and an LCD viewfinder and said rear retainer face is provided with a control-panel aperture and an LCD-viewfinder aperture such that said camera is operatable while said camera is held within said retainer.

9: The case of claim 8, wherein said LCD viewfinder aperture has a removable plug such that said removable plug may be placed into said LCD viewfinder aperture to protect said LCD viewfinder on said camera.

10: The case of claim 10, wherein said removable plug is transparent so that said camera is operable without removing said removable plug.

11: The case of claim 1 further comprising a storage means with an access slot, wherein said sleeve has a sleeve wall and said storage means is formed by a recess in said sleeve wall and a frame, and wherein a storage device is slidably insertable into said storage means via said access slot.

12: The case of claim 11, wherein said access slot is provided on an outer face of said sleeve wall.

13: The case of claim 12, wherein said storage means has an extraction aperture for allowing a user to push said storage device out of said storage means.
